(19) United States
(12) Patent Application Publication
(10) Pub. No.: US 2025/0030541 A1
(43) Pub. Date: Jan. 23, 2025

(54) QUANTUM CRYPTOGRAPHIC COMMUNICATION SYSTEM, COMMUNICATION DEVICE, AND CONTROL METHOD THEREOF

(71) Applicant: NEC Corporation, Minato-ku, Tokyo (JP)

(72) Inventor: Hiroshi IMAI, Tokyo (JP)

(73) Assignee: NEC Corporation, Minato-ku, Tokyo (JP)

(21) Appl. No.: 18/716,551

(22) PCT Filed: Dec. 16, 2021
(86) PCT No.: PCT/JP2021/046596

§ 371 Date: Jun. 5, 2024

(51) Int. Cl. H04L 9/08; H04L 9/12

(52) U.S. Cl. CPC H04L 9/0852; H04L 9/12

(57) ABSTRACT

A quantum cryptographic communication system includes a transmitter (Alice) and a receiver (Bob) which are optically connected through an optical transmission line. The transmitter transmits signal light having a quantum state and reference light having no quantum state to the receiver through the optical transmission line. The receiver includes an optical amplifier that amplifies the reference light; a homodyne detector that generates a signal output based on amplified reference light and the received signal light; a level detector that detects a signal output level from the signal output; and an optical amplifier controller that controls a gain of the optical amplifier based on at least the signal output level.

### TECHNICAL FIELD

The present invention relates to a quantum cryptographic communication system, and in particular to a communication device and a control method for the communication device that shares an encryption key through quantum cryptographic communication.

### BACKGROUND ART

In the field of optical communications, quantum key distribution (QKD) systems have been studied actively and put into practical use as a means of achieving high confidentiality in transmission channels. Recently, continuous-variable QKD has been proposed, which uses continuous variables such as the quadrature-phase amplitude of light instead of discrete variables in photon units. In particular, homodyne detection has attracted attention. The reason is that the homodyne detection measures the quadrature-phase amplitude at the receiver side, allowing measurement near the quantum noise limit to achieve high quantum efficiency even in the case of ordinary photodiodes used at room temperature (Patent literature (PTL) 1).

According to PTL 1, in continuous-variable QKD, the laser light is split into a reference light (hereinafter referred to as LO (Local Oscillation) light and a signal light by a beam splitter at a transmitter (Alice) terminal. The LO light and the randomly phase-modulated weak signal light are transmitted to the receiver (Bob) terminal. At the receiver terminal, the arriving LO light is randomly phase-modulated. The LO light thus obtained and the arriving weak signal light are detected by two photodetectors through a beam splitter. The homodyne detection enables the extraction of the phase information of the signal light that has been phase-modulated at the transmitter.

As described in PTL 1, the level average of the signal light obtained by homodyne detection is represented by 2√(n1)√(n0), wherein n1 is the number of photons of the signal light and n0 is the number of photons of the LO light. It is known that the transmission loss of an optical fiber is more than 0.2 dB/km. The optical power is attenuated by 10 dB, or 1/10, at a transmission distance of 50 km, and by 1/100 at a transmission distance of 100 km. Accordingly, the signal level obtained by homodyne detection is similarly reduced to 1/10 and 1/100 or less at transmission distances of 50 km and 100 km, respectively.

Such signal level attenuation degrades the signal-to-noise (SN) ratio in homodyne detection. It is necessary to increase the signal level to prevent SN ratio degradation. However, the installation of an optical amplifier on the transmission line cannot be adopted because the signal light is also amplified in the transmission line, which may affect the cryptographic key information. As an alternative, the laser output power of the transmitter terminal may also be increased. However, to compensate for the above signal level attenuation, the output power of the laser light source must be significantly increased, for example, from 10 mW (Class 1) to 1 W (Class 4) in the case of the laser class of a wavelength band of 1.5 μm. Such a power-increase measure may be impractical due to upsizing of equipment, durability problems with optical components, and reduced security during transmission.

To improve the SN ratio in homodyne detection, a measure of amplifying only LO light at the receiver terminal has been proposed in PTL 2.

### CITATION LIST

### Patent Literature

[PTL 1] Japanese Patent Application Publication No. 2000-101570
[PTL 2] Japanese Patent Application Publication No. 2007-266738

### SUMMARY OF INVENTION

### Technical Problem

However, Patent document 2 describes merely amplification of the LO light for improvement of SN ratio in homodyne detection, not describing how the amplification is controlled to achieve the improvement of the SN ratio.

In addition to improving the SN ratio in homodyne detection, it is also important to stabilize the signal output level obtained based on the LO light and signal light. In the Patent document 2, the amplified LO light is used to control the timing of the phase modulation process. Accordingly, although high precision in timing control may be achieved, it is not possible to obtain the stability of the signal output level.

Therefore, an object of the present invention is to provide a quantum cryptographic communication system, a communication device, and a communication control method that can achieve improvement in SN ratio and stability of the signal output in homodyne detection.

### Solution to Problem

According to an aspect of the present disclosure, a quantum cryptographic communication system includes a transmitter and a receiver which are connected via a communication network, wherein the transmitter and the receiver are optically connected through an optical transmission line, the transmitter includes: a beam splitter that splits coherent light into first light and second light; and an optical transmission section configured to: generate signal light having a quantum state by applying phase modulation and intensity attenuation to the first light, wherein the second light is used as reference light having no quantum state; and transmit the signal light and the reference light to the optical transmission line, and the receiver includes: an optical reception section configured to receive the signal light and the reference light arriving through the optical transmission line; an optical amplifier that amplifies the reference light received by the optical reception section while maintaining wavelength and phase of the reference light; a phase modulator that phase-modulates the reference light output from the optical amplifier; a homodyne detector that generates a signal output based on phase-modulated reference light and the signal light arriving through the optical transmission line; a level detector that detects a signal output level from the signal output; and an optical amplifier controller that controls a gain of the optical amplifier based on at least the signal output level.

According to an aspect of the present invention, a communication device that detects a signal output by homodyne detection in a quantum cryptographic communication system, includes an optical reception section configured to receive signal light and reference light arriving through an optical transmission line, wherein the signal light and the reference light are generated from coherent light at a transmitting-side communication device, wherein the signal light is weak-intensity light having a quantum state and the reference light is light having no quantum state; an optical amplifier that amplifies the reference light received by the optical reception section while maintaining wavelength and phase of the reference light; a phase modulator that phase-modulates the reference light output from the optical amplifier; a homodyne detector that generates the signal output based on phase-modulated reference light and the signal light arriving through the optical transmission line; a level detector that detects a signal output level from the signal output; and an optical amplifier controller that controls a gain of the optical amplifier based on at least the signal output level.

According to one aspect of the invention, a control method in a communication device that detects a signal output by homodyne detection in a quantum cryptographic communication system, includes: by an optical reception section, receiving signal light and reference light arriving through an optical transmission line, wherein the signal light and the reference light are generated from coherent light at a transmitting-side communication device, wherein the signal light is weak-intensity light having a quantum state and the reference light is light having no quantum state; by an optical amplifier, amplifying the reference light received by the optical reception section while maintaining wavelength and phase of the reference light; by a phase modulator, phase-modulating the reference light output from the optical amplifier; by a homodyne detector, generating the signal output based on phase-modulated reference light and the signal light arriving through the optical transmission line; by a level detector, detecting a signal output level from the signal output; and by an optical amplifier controller, controlling a gain of the optical amplifier based on at least the signal output level.

### Advantageous Effects of Invention

As described above, according to the present invention, improvement in SN ratio and stability of the signal output in homodyne detection can be achieved.

### BRIEF DESCRIPTION OF DRAWINGS

FIG. 1 is a block diagram illustrating the schematic configuration of a QKD system according to a first example embodiment of the present invention.

FIG. 2A is a graph to illustrate the signal-to-noise ratio at low received signal levels.

FIG. 2B is a graph to illustrate improvements of signal-to-noise ratio in the case where the present example embodiment is applied.

FIG. 3 is a block diagram illustrating the schematic configuration of a QKD system according to a second example embodiment of the present invention.

FIG. 4 is a block diagram illustrating the configuration of a transmitter (Alice) of the QKD system according to a first example of the present invention.

FIG. 5 is a block diagram illustrating the configuration of a receiver (Bob) of the QKD system according to the first example.

FIG. 6 is a flowchart illustrating a reception control method of the receiver (Bob) of the QKD system according to the first example.

FIG. 7 is a block diagram illustrating the configuration of a receiver (Bob) in a QKD system according to a second example of the present invention.

FIG. 8 is a schematic diagram to illustrate effects of disturbances on the spatially propagating laser beam of the QKD system according to the second example.

FIG. 9A is a schematic diagram illustrating a light-receiving state of the receiver under normal beam profile condition.

FIG. 9B is a schematic diagram illustrating a light-receiving state of receiver under degraded beam profile condition.

FIG. 10 is a flowchart illustrating a reception control method of the receiver (Bob) in the QKD system according to the second example.

### DETAILED DESCRIPTION

### Outline of Example Embodiments

According to an example embodiment of the present invention, in a system in which a transmitting-side communication device transmits weak signal light with a quantum state and reference light of normal intensity without quantum state to a receiving-side communication device, the receiving-side communication device includes an optical amplifier that amplifies only reference light. The optical gain of the optical amplifier is controlled based on at least a signal output level obtained by homodyne detection. Accordingly, the intensity of the reference light can be increased, thereby improving the signal-to-noise ratio in homodyne detection. In addition, stabilization of the signal output can be achieved by controlling the optical gain of the optical amplifier.

Hereinafter, example embodiments of the present invention will be described in detail with reference to the drawings. However, the components described in the following example embodiments and examples are merely examples, and are not intended to limit the technical scope of the present invention to these embodiments and examples alone.

### 1. EXAMPLE EMBODIMENTS

### First Example Embodiment

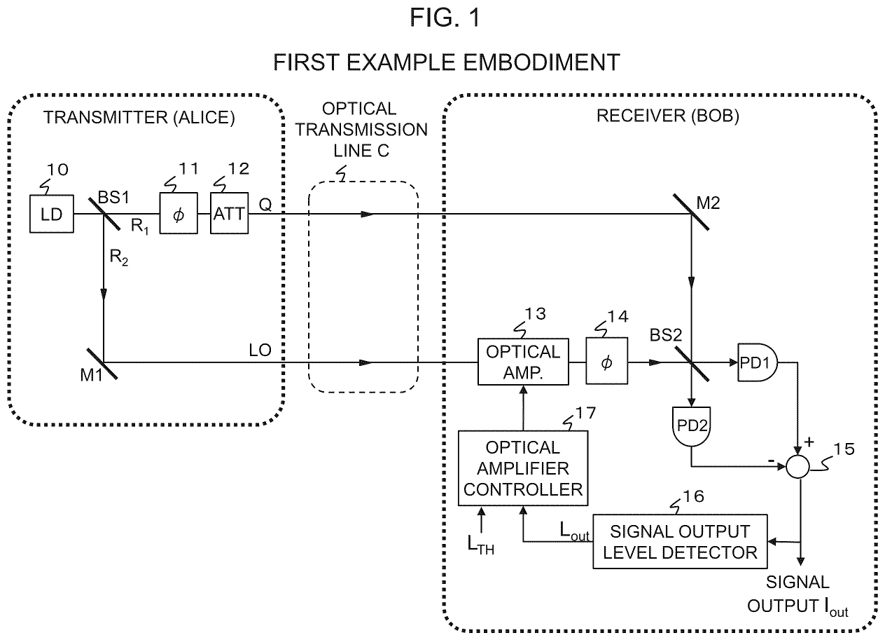

As illustrated in FIG. 1, cryptographic communication can be performed between a communication device including a transmitter (Alice) and a communication device including a receiver (Bob) by using a quantum cryptographic key generated between those communication devices. Here, it is assumed that the transmitter (Alice) and receiver (Bob) are optically connected by an optical transmission line C. As described below, the concept of optical transmission line C may include not only optical fiber but also free space.

The transmitter (Alice) includes a laser source 10, a beam splitter BS1 and an optical transmission section. The optical transmission section includes a phase modulator 11, an attenuator 12 and a mirror M1. The laser source 10 generates coherent light, which is split into two light beams on routes R₁ and R₂ by the beam splitter BS1. One light beam on the route R₁ is modulated by the phase modulator 11 and then attenuated by the attenuator 12 to generate weak signal light Q with quantum states. The weak signal light Q is transmitted through the optical transmission line C. The other light beam on the route R₂ is reflected at the by mirror M1 and is sent out to the optical transmission line C as reference light LO having normal intensity without quantum state. As described in the above-mentioned Patent Document 1, the intensity of reference light LO is significantly greater than that of signal light Q. For example, the signal light Q has an intensity of about one photon, while the reference light LO has an intensity of about 10 million photons.

The receiver (Bob) includes an optical amplifier 13, a phase modulator 14, a mirror M2, and a homodyne detector. The homodyne detector includes a beam splitter BS2, two photodetectors PD1 and PD2, and a subtractor 15. The receiver (B0b) further includes a signal output level detector 16 and an optical amplifier controller 17.

The optical amplifier 13 amplifies reference light LO arriving from the transmitter (Alice) while maintaining the wavelength and phase. The phase modulator 14 phase-modulates the amplified reference light LO and outputs the phase-modulated reference light LO to the beamsplitter BS2. The signal light Q arriving from the transmitter (Alice) is reflected by the mirror M2 and enters the beam splitter BS2. The beam splitter BS2 has equal light transmittance and reflectance, which superimposes as inputs the phase-modulated, received reference light LO and the received signal light Q reflected by the mirror M2. In other words, the beam splitter BS1 of the transmitter (Alice) and the beam splitter BS2 of the receiver (Bob) constitute one interferometer composed of two equal-length routes R₁ and R₂.

Two light beams output from the beam splitter BS2 are incident on the photodetectors PD1 and PD2, respectively. The photodetectors PD1 and PD2 convert the two light beams to electrical signals, respectively, which are output as detection signals to the subtractor 15. The subtractor 15 calculates a difference between the detection signals to output a difference signal. The difference signal is a signal output Iₒᵤₜ obtained by homodyne detection. The photodetectors PD1 and PD2 may employ normal photodiodes operable at room temperature.

The signal output level detector 16 detects the level or average of the signal output Iₒᵤₜ. For example, a low-pass filter can be used as the signal output level detector 16. The optical amplifier controller 17 inputs the level signal Lₒᵤₜ obtained by the signal output level detector 16 and controls the gain, or amplification factor, of the optical amplifier 13 so that the level signal Lₒᵤₜ is maintained within a predetermined range of a threshold L_{TH} or more. For example, if the level signal Lₒᵤₜ of the signal output Iₒᵤₜ drops below the threshold L_{TH} due to a larger transmission loss in the optical transmission line C, the optical amplifier controller 17 can increase the gain of the optical amplifier 13 to compensate for the transmission loss.

The optical amplifier 13 can amplify the reference light LO received from the transmitter (Alice) while maintaining its wavelength and phase without transducing it to electricity. Further, the gain of the optical amplifier 13 can be controlled. For example, an EDFA (Erbium-Doped Fiber Amplifier), a SOA (Semiconductor Optical Amplifier) or the like can be used as the optical amplifier 13. In the case where the EDFA is used for the optical amplifier 13, the received reference light LO can be amplified with a high efficiency such as more than 80% amplification efficiency for pumping light. The optical gain of the EDFA can be controlled by controlling the current supplied to a laser source of the pumping light. In the case of the optical amplifier 13 being the SOA, the gain can be controlled by the current supplied to the SOA. Assuming that the optical transmission line C is an optical fiber, the optical amplifier 13 providing a gain of 20 dB can compensate for attenuation equivalent to a 100 km-long optical fiber.

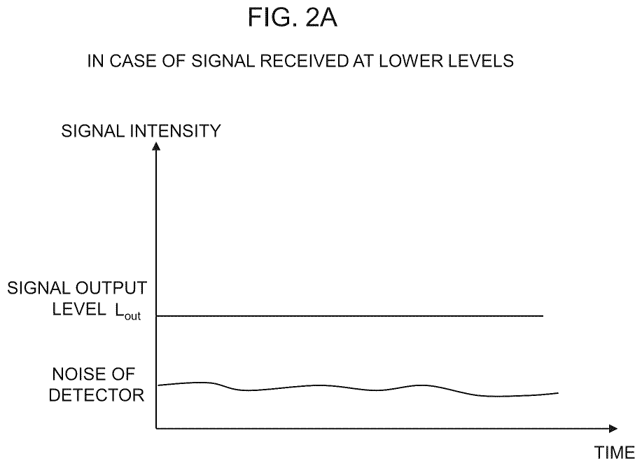

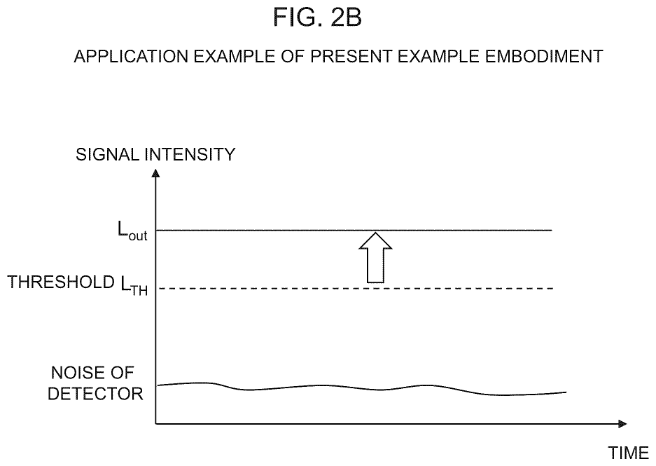

As described above, according to the first example embodiment of the present invention, the optical amplifier 13 that amplifies only the reference light is provided in the receiver (Bob), and the amplification, or gain, of the optical amplifier 13 is controlled based on the signal output level Lₒᵤₜ obtained by homodyne detection. This allows the increased intensity of the reference light, thereby improving the signal-to-noise (SN) ratio in homodyne detection, as illustrated in FIGS. 2A and 2B.

As illustrated in FIG. 2A, as the signal output level Lₒᵤₜ is lower due to a large transmission loss of the free-space transmission line C, the ratio (signal-to-noise ratio) of the signal output level Lₒᵤₜ to the noise level of photodetectors PD1 and PD2 becomes lower. In contrast, according to the present example embodiment, as illustrated in FIG. 2B, the gain of the optical amplifier 13 is controlled so that the signal output level Lₒᵤₜ can be maintained at the threshold value L_{TH} or more corresponding to a predetermined SN ratio. Therefore, even in the case where the transmission loss of the optical transmission line C is large, the SN ratio in homodyne detection at the receiving side can be improved without increasing the power of the laser light source 10 nor interposing an optical amplifier in the optical transmission line C.

Furthermore, the optical amplifier controller 17 adjusts the gain of the optical amplifier 13 according to the comparison result between the signal output level Lₒᵤₜ and the threshold L_{TH}, allowing the signal output level Lₒᵤₜ to be maintained within a predetermined range, resulting in stabilization of the signal output Iₒᵤₜ. Furthermore, when the optical transmission line is switched by, for example, an optical switch at a time when detecting an unauthorized interception of quantum cryptographic communication, it is possible to deal with differences in transmission loss before and after switching the optical transmission line.

### Second Example Embodiment

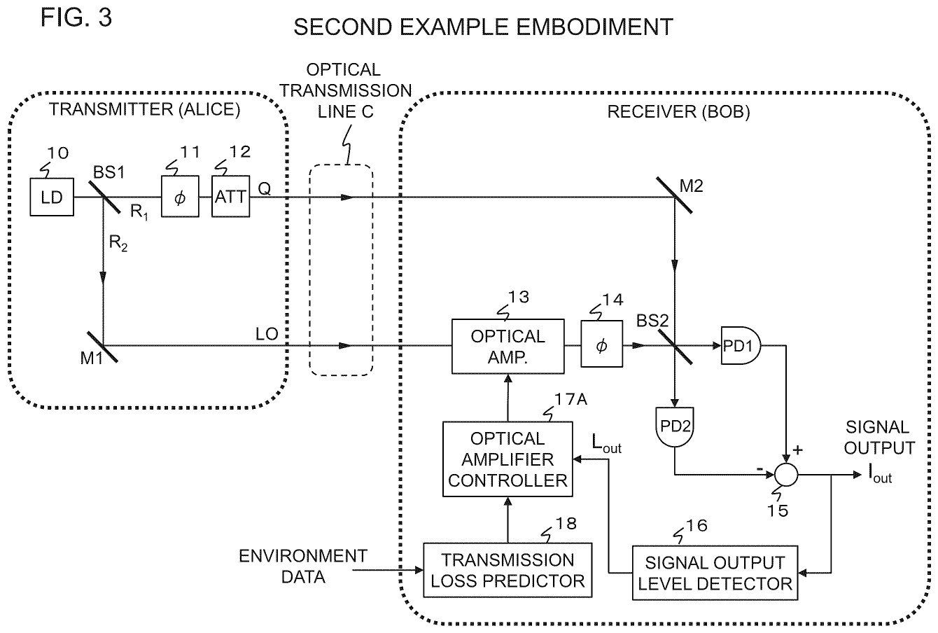

As illustrated in FIG. 3, a system according to a second example embodiment of the present invention includes the receiver (Bob) different in configuration from the first example embodiment shown in FIG. 1. Hereinafter, the configuration and functions that differ from those of the first example embodiment will be described. Components similar to those previously described in FIG. 1 will be denoted by the same reference numerals and their details are omitted.

In FIG. 3, the receiver (Bob) has basically the same configuration as in the first example embodiment, but additionally includes a transmission loss predictor 18. Accordingly the control function of the optical amplifier controller 17A is slightly different from that of the optical amplifier control section 17. The transmission loss predictor 18 predicts changes in the loss of reference light propagating through the optical transmission line C based on environment data. The optical amplifier controller 17A controls the gain of the optical amplifier 13 to cancel the change in transmission loss predicted by the transmission loss predictor 18 while monitoring the level signal Lₒᵤₜ of the signal output Iₒᵤₜ as in the first embodiment.

The environment data is data of factors that affect the transmission loss of the optical transmission line C, such as temperature, humidity, vibration, etc. In addition, the environment data may include time data such as date and a time of day. As is well known, if the optical transmission line C is an optical fiber, the optical path length and transmission loss may vary with temperature and vibration. If the optical transmission line C is free space, the transmission loss may vary with temperature and humidity. Since temperature and humidity also vary with the seasons, fluctuations in transmission loss may be roughly predicted according to date. Further, temperature and humidity change with the time of day, and the frequency or magnitude of vibrations caused by traffic and other factors also vary. Increased vibration may cause positional misalignment at the incoming and outgoing sections of the optical transmission line C, leading to changes in loss.

Such environment data that affect the transmission loss of the optical transmission line C may be measured in advance. Using such measured environment data, the relationship between environment and transmission loss can be prepared as a conversion table. By searching this conversion table according to the current environment data as input, the transmission loss predictor 18 can predict the transmission loss of the optical transmission line C. Accordingly, the optical amplifier controller 17A, when inputting the transmission loss predicted by the transmission loss predictor 18, can control the gain to compensate for the transmission loss.

As described above, according to the second example embodiment of the present invention, the optical amplifier controller 17A controls the gain of the optical amplifier 13 based on the level signal Lₒᵤₜ of the current signal output out and the transmission loss predicted by the transmission loss predictor 18. Such gain control can improve the SN ratio in homodyne detection as in the first example embodiment. Further even if the transmission loss of the optical transmission line C increases, it is possible to predict the change in the transmission loss, allowing the signal output Iₒᵤₜ to be stabilized quickly and precisely.

### 2. EXAMPLES

Hereinafter, a system in which signal light Q and reference light LO are transmitted in a single transmission line will be described as an example. A first example describes a system using an optical fiber as the optical transmission line, and a second example describes a system using free space as the optical transmission line.

### 2.1) First Example

### <Configuration>

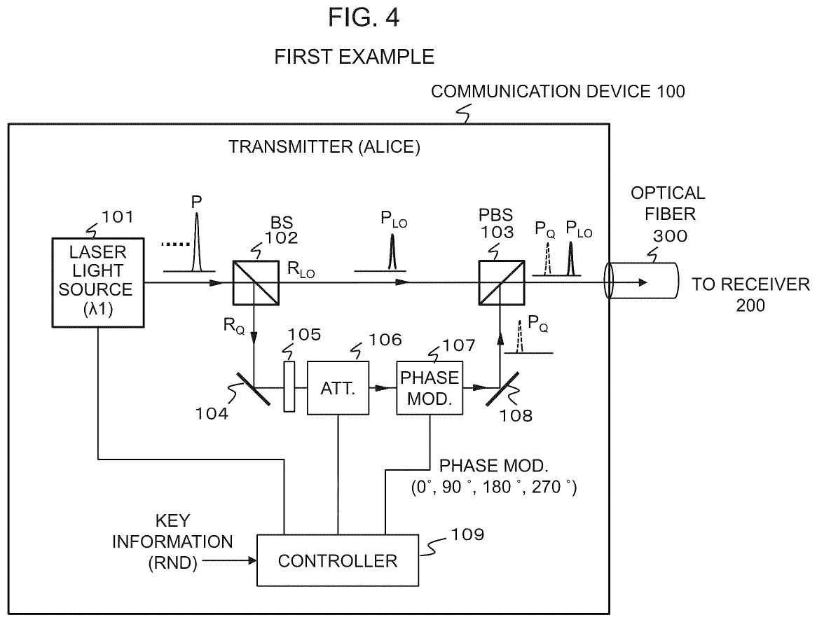

As illustrated in FIG. 4, a quantum cryptographic communication system according to the first example of the present invention comprises a communication device 100 including a transmitter (Alice) and a communication device 200 including a receiver (Bob). The transmitter (Alice) includes a laser light source 101, polarizing beam splitters (PBS) 102 and 103, mirror 104, a half-wave plate 105, an attenuator 106, a phase modulator 107, a mirror 108, and a controller 109. Here, the input port of the unpolarizing beam splitter 102 is connected to the output port of the laser light source 101, and the output port of the polarizing beam splitter 103 is connected to the optical fiber 300.

The laser light source 101 outputs linearly polarized light pulses P to the input port of the polarizing beam splitter 102. A light pulse P is split by the unpolarizing beam splitter 102 into two light pulses, which propagate through a reference-side route R_{LO} and a signal-side route R_{Q}, respectively.

A light pulse on the reference-side route R_{LO} passes through the polarizing beam splitter 103 as it is, and enters the optical fiber 300 as a normal-intensity reference light pulse P_{LO} having no quantum state. A light pulse on the signal-side route R_{Q} enters the polarizing beam splitter 103 through mirror 104, half-wave plate 105, attenuator 106, phase modulator 107 and mirror 108. The light pulse reflected by the mirror 108 on the signal-side route R_{Q} is further reflected by the polarizing beam splitter 103 as a weak signal light pulse P_{Q} having a quantum state and then enters the optical fiber 300. The half-wave plate 105 rotates the polarization direction of the light pulse on the signal-side route R_{Q} by 90 degrees. The attenuator 106 reduce the intensity of the light pulse to generate a weak light pulse with a quantum state. The phase modulator 107 phase-modulates the weak light pulse to generate the weak signal light pulse P_{Q}. The attenuator 106 and the phase modulator 107 may be arranged in reverse order with respect to the direction of the light pulse.

Here, the signal-side route R_{Q} has a longer optical path than the reference-side route R_{LO}. An optical system composed of the half-wave plate 105 and the unpolarizing beam splitters 102 and 103 with a difference in optical path length between the signal-side route R_{Q} and the reference-side route R_{LO} generates the reference light pulse P_{LO} and the weak signal light pulse P_{Q} from a single light pulse P. Accordingly, the reference light pulse P_{LO} and the weak signal light pulse P_{Q} are separated in time and their polarization directions are orthogonal to each other. If the unpolarizing beam splitter 102 is replaced with a polarizing beam splitter, the half-wave plate 105 does not need to be used.

The controller 109 performs control of the communication device 100, particularly hereinafter controls of the laser light source 101, attenuator 106, and phase modulator 107 related to the transmitter (Alice). More specifically, the controller 109 drives the phase modulator 107 in four different phases (0°, 90°, 180°, 270°) according to random number of a raw cryptographic key. The phase modulator 107 performs phase modulation on the weak light pulse received from the attenuator 106 according to key information to generate a signal light pulse P_{Q}. In this manner, a pulse train of a normal-intensity reference light pulse P_{LO} and a phase-modulated signal light pulse P_{Q} is transmitted to the receiver (Bob) through the optical fiber 300.

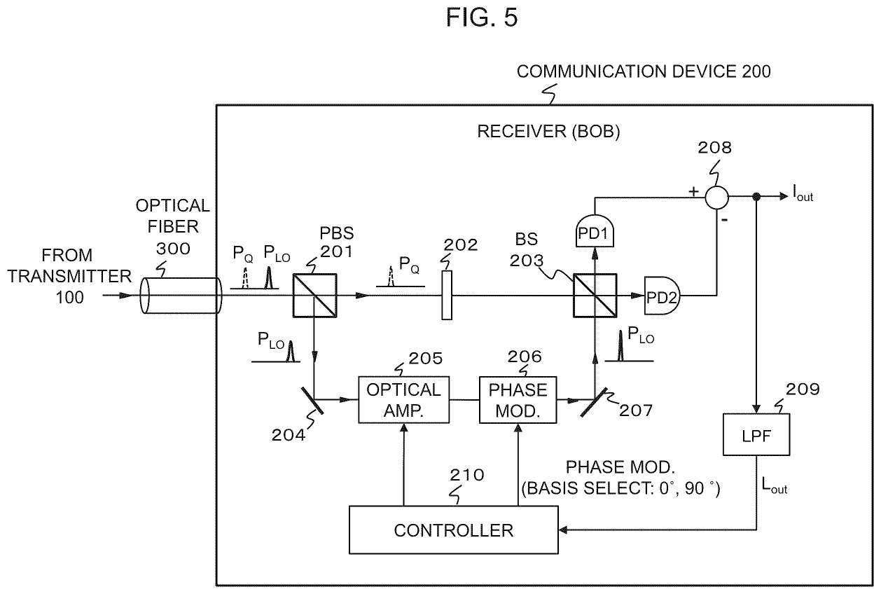

As illustrated in FIG. 5, the receiver (Bob) of the quantum cryptographic communication system according to the first example of the present invention receives a reference light pulse P_{LO} and a signal light pulse P_{Q} whose polarization directions are perpendicular to each other from the transmitter (Alice) through the optical fiber 300. The receiver (Bob) includes a polarizing beam splitter 201 whose input port is connected to the optical fiber 300. The received signal light pulse P_{Q} passes through the polarizing beam splitter 201 to be outputted as it is from a first output port of the polarizing beam splitter 201 to a first input port of the unpolarizing light beam splitter 203 through a half-wave plate 202. The half-wave plate 202 rotates the polarization direction of the received signal light pulse P_{Q} by 90 degrees. The reference light pulse P_{LO} is reflected by the polarizing beam splitter 201 to be outputted from a second output port of the polarizing beamsplitter 201 to a second input port of the unpolarizing light beam splitter 203 through a mirror 204, optical amplifier 205, phase modulator 206 and mirror 207.

It should be noted that the route of the received signal light pulse P_{Q} is the same length as the route R_{LO} of the transmitter (Alice), and the route of the received reference light pulse P_{LO} is the same length as the route R_{Q} of the transmitter (Alice). Accordingly, the received signal light pulse P_{Q} and the received reference light pulse P_{LO}, which enter the first and second input ports of the unpolarizing beam splitter 203, respectively, reach the unpolarizing beam splitter 203 through different optical paths of the same length from the unpolarizing beam splitter 102 of the transmitter (Alice). The optical configuration of the transmitter (Alice) and receiver (Bob) thus constitutes an interferometer as described in FIG. 1.

The optical amplifier 205 may employ, for example, an EDFA or SOA. The optical amplifier 205 amplifies the received reference light pulse P_{LO} while maintaining its wavelength and phase. The gain of the optical amplifier 205 is controlled by the controller 210 as described later. The phase modulator 206 phase-modulates the optically amplified, received reference light pulse P_{LO}. The phase modulation of the phase modulator 206 is controlled by the controller 210. As described above, the phase modulator 107 of the transmitter (Alice) performs four different phase modulations (0°, 90°, 180°, 270°) on the signal light pulse P_{Q} to be transmitted, while the phase modulator 206 of the receiver (Bob) performs two different phase modulations (0°, 90°) on the received reference light pulse P_{LO}.

The unpolarizing beam splitter 203 inputs the received signal light pulse P_{Q} that has passed through the half-wave plate 202 and the received reference light pulse P_{LO} that has been amplified and phase-modulated. The unpolarizing beam splitter 203 has equal light transmittance and reflectance. Accordingly, the unpolarizing beam splitter 203 superimposes the received signal light pulse P_{Q} and the received reference light pulse P_{LO} to emit the resultant from the two output ports. Photodetectors PD1 and PD2 input two outgoing beams of light from the two output ports of the unpolarizing beam splitter 203, respectively. The photodetectors PD1 and PD2 may be normal photodiodes used at room temperature.

A subtractor 208 performs subtraction calculation of detection signals output from the photodetectors PD1 and PD2, respectively, and outputs the resulting difference signal as signal output Iₒᵤₜ obtained by homodyne detection.

A low-pass filter 209 averages the signal output Iₒᵤₜ to output the level signal Lₒᵤₜ to the controller 210. The controller 210 controls the communication device 200, and here it performs phase control of the phase modulator 206 and gain control of the optical amplifier 205 in the receiver (Bob). The gain control of the optical amplifier 205 is the same function as the optical amplifier controller 17 in the first example embodiment described above. More specifically, the controller 210 inputs the level signal Lₒᵤₜ from the low-pass filter 209 and controls the gain of the optical amplifier 205 so that the level signal Lₒᵤₜ can be maintained within a predetermined range of the threshold L_{TH} or more. As described referring to FIG. 2, the controller 210 increases the gain of the optical amplifier 205 when the level signal Lₒᵤₜ drops below the threshold L_{TH} due to a larger transmission loss in the optical fiber 300. Increasing the gain of the optical amplifier 205 can compensate for the transmission loss.

### <Optical Gain Control>.

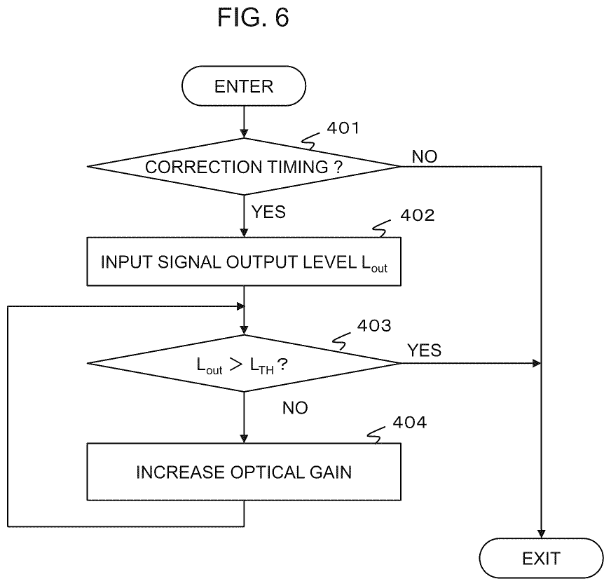

It is assumed in the quantum cryptographic communication system according to the present example that the cryptographic communication using quantum keys between the communication devices 100 and 200 is performed according to predetermined time slots. According to the present example, as illustrated in FIG. 6, the controller 210 monitors the level signal Lₒᵤₜ of the signal output Iₒᵤₜ for each communication time slot to adjust the optical gain of the optical amplifier 205.

Referring to FIG. 6, the controller 210 determines whether or not it is correction timing for each predetermined time slot (operation 401). If it is the correction timing (YES in operation 401), the controller 210 inputs the level signal Lₒᵤₜ from the low-pass filter 209 (operation 402). The controller 210 determines whether the level signal Lₒᵤₜ exceeds the threshold L_{TH} (operation 403). If the level signal Lₒᵤₜ is not greater than the threshold L_{TH} (NO in operation 403), the controller 210 increases the gain of the optical amplifier 205 (operation 404). When the level signal Lₒᵤₜ exceeds the threshold L_{TH} (YES in operation 403), the optical gain control is terminated. If it is not the correction timing (NO in operation 401), the optical gain control is not performed.

As described above, the controller 210 monitors the level signal Lₒᵤₜ of the signal output Iₒᵤₜ at predetermined timings to adjust the optical gain of the optical amplifier 205, thereby maintaining the level of the signal output Iₒᵤₜ at levels exceeding the threshold L_{TH}. Furthermore, the gain of the optical amplifier 205 is adjusted periodically, thereby improving the stability of the signal output Iₒᵤₜ.

### 2.2) Second Example

### <Configuration>

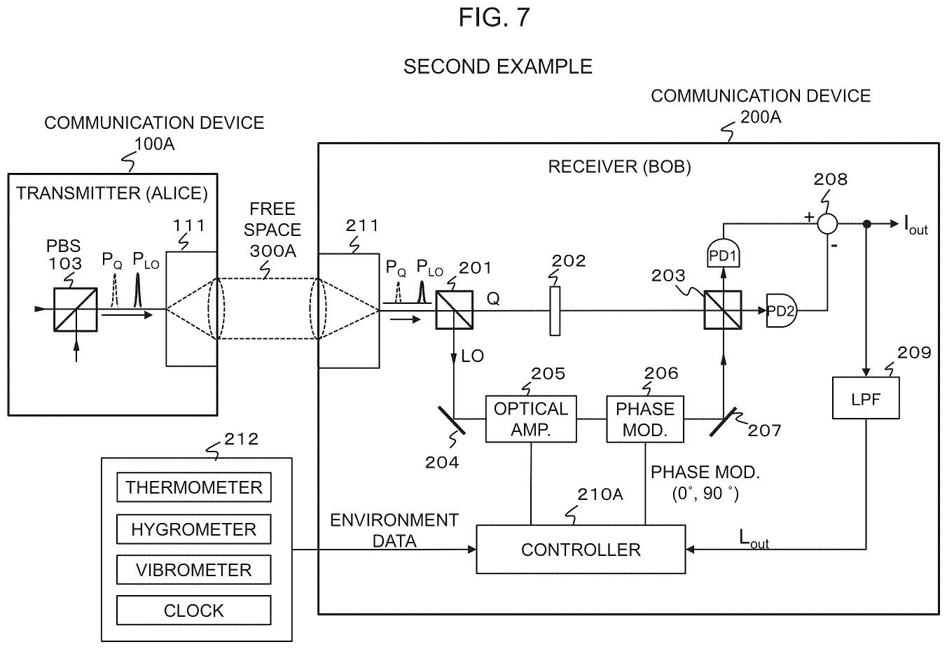

As illustrated in FIG. 7, a quantum cryptographic communication system according to the second example of the present invention is composed of a communication device 100A including a transmitter (Alice) and a communication device 200A including a receiver (Bob), and uses free space 300A as an optical transmission line. In this example, beam expanders 111 and 211 are provided as optical transmitting means and optical receiving means in the communication devices 100A and 200A, respectively. The beam expanders 111 and 211 are installed with aligning their optical axes with each other, allowing a normal-intensity reference light pulse P_{LO} and a weak signal light pulse P_{Q} with quantum state to be transmitted through the free space 300A.

The configuration of the transmitter (Alice) is the same as in the first example shown in FIG. 4, except for the beam expander 111. Accordingly, the detailed configuration of the transmitter (Alice) is omitted in FIG. 7. Since the configuration of the receiver (Bob) is basically the same as in the first example shown in FIG. 5, except for the beam expander 211, components having the same functions are denoted by the same reference numerals, and their descriptions are omitted. Hereinafter, the configuration and functions that differ from those in the first example are mainly described.

In the transmitter (Alice), the beam expander 111 is optically connected to the output port of the polarizing beam splitter 103. The reference light pulse P_{LO} and the signal light pulse P_{Q} are emitted from the output port of the polarizing beam splitter 103 and transmitted from the beam expander 111 to the beam expander 211 of the receiver (Bob) through the free space 300A. The beam expander 111 transmits the reference light pulse P_{LO} and the signal light pulse P_{Q} as collimated light with larger diameter.

When the beam expander 211 of the receiver (Bob) receives the reference light pulse P_{LO} and the signal light pulse P_{Q}, the signal output Iₒᵤₜ is obtained by homodyne detection as already described. A controller 210A inputs the level signal Lₒᵤₜ of the signal output Iₒᵤₜ from the low-pass filter 209 and environment data from various external sensors 212. The environment data are data of factors that affect the transmission loss of the free space 300A, such as temperature, humidity, vibration, etc. In addition, the environment data may include time data such as date and a time of day.

The controller 210A has a control function of the optical amplifier controller 17A and a transmission loss prediction function of the transmission loss predictor 18 as shown in FIG. 3. Accordingly, the controller 210A controls the gain of the optical amplifier 205 to cancel the predicted transmission loss change while monitoring the level signal Lₒᵤₜ of the signal output Iₒᵤₜ.

The controller 210A holds a conversion table containing a relationship between environments and transmission losses by measuring in advance environment data that affects the transmission loss of the free space 300A. Accordingly, when inputting the current environment data from the various sensors 212, the controller 210A can predict the transmission loss of the free space 300A by referring to the conversion table. In this manner, the optical gain of the optical amplifier 205 can be adjusted to compensate for the predicted transmission loss.

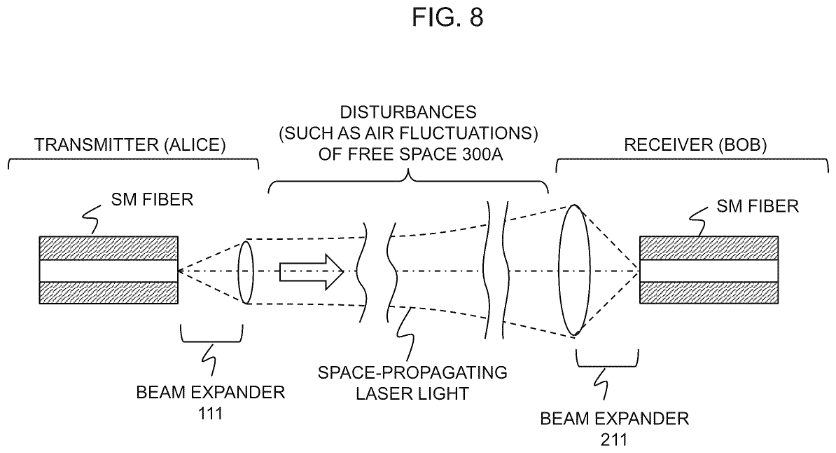

As illustrated in FIG. 8, it is assumed in the transmitter (Alice) that the output port of the polarizing beam splitter 103 and the input port of the beam expander 111 are connected by a single-mode (SM) optical fiber. It is also assumed in the receiver (Bob) that the output port of the beam expander 211 and the input port of the polarizing beam splitter 201 are connected by a SM optical fiber. When laser light is sent from the beam expander 111 to the beam expander 211 through the free space 300A, the output light of the beam expander 211 of the receiver (Bob) may not be concentrated correctly onto the core of the SM optical fiber due to disturbances such as air fluctuations in the free space 300A. Also, the intensity of the output light of the beam expander 211 may be greatly reduced due to disturbances such as water vapor and particulates in the free space 300A.

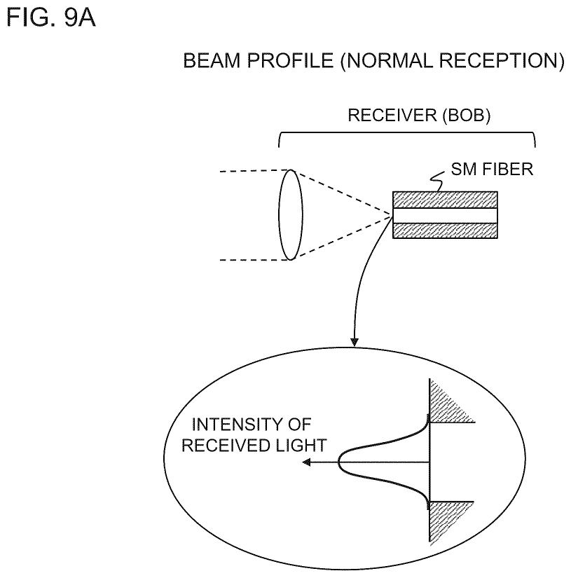

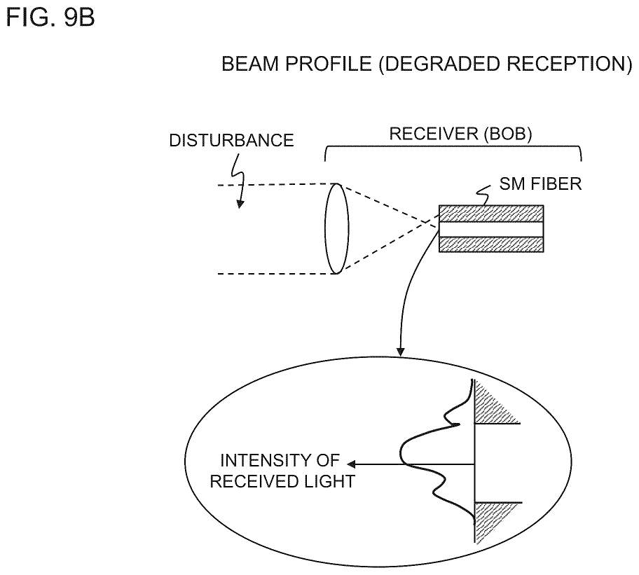

For example, as shown in FIG. 9A, when the output light of beam expander 211 of the receiver (Bob) is correctly concentrated onto the core of the SM optical fiber, the sufficient intensity of received light is obtained at the SM optical fiber, allowing the received light of sufficient intensity to enter the input port of the polarizing beam splitter 201. However, as shown in FIG. 9B, when the output light of beam expander 211 is not correctly concentrated onto the core of the SM optical fiber due to disturbances in the free space 300A, the intensity distribution of received light at the SM optical fiber is distorted significantly, resulting in insufficient intensity of received light entering the input port of the polarizing beam splitter 201 from the SM optical fiber.

As described above, when using the free space 300A as an optical transmission line, it is necessary to take into account fluctuations in the received light intensity due to disturbances. According to the second example of the present invention, the controller 210A controls the gain of the optical amplifier 205 based on the level signal Lₒᵤₜ of the current signal output Iₒᵤₜ and the predicted transmission loss. Accordingly, the gain of the optical amplifier 205 can be controlled according to predicted changes in the transmission loss of the free space 300A, allowing quick and precise stabilization of the signal output Iₒᵤₜ. Furthermore, in the case where the optical transmission line is switched by, for example, an optical switch at a time when an unauthorized interception of quantum cryptographic communication is detected, it is possible to cope with differences in transmission loss before and after the switching operation.

### <Optical Gain Control>

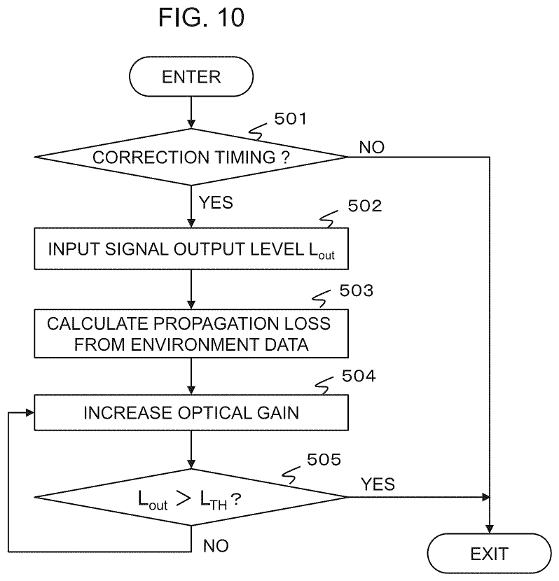

It is assumed in the quantum cryptographic communication system according to the present example that the cryptographic communication using quantum keys between the communication devices 100A and 200A is performed according to predetermined time slots. According to the present example, as illustrated in FIG. 10, the controller 210A monitors the level signal Lₒᵤₜ of the signal output Iₒᵤₜ for each communication time slot to adjust the gain of the optical amplifier 205.

Referring to FIG. 10, the controller 210A determines whether or not it is correction timing for each predetermined time slot (operation 501). If it is the correction timing (YES in operation 501), the controller 210A inputs the level signal Lₒᵤₜ from the low-pass filter 209 (operation 502). Further, the controller 210A inputs environment data from the various sensors 212 and calculates transmission loss using the conversion table and the like as described before (operation 503). The controller 210A increases the gain of the optical amplifier 205 to compensate for the calculated transmission loss (operation 504) and determines whether the level signal Lₒᵤₜ exceeds the threshold L_{TH} (operation 505). If the level signal Lₒᵤₜ is not greater than the threshold L_{TH} (NO in operation 505), the controller 210A increases the gain of the optical amplifier 205 so that the level signal Lₒᵤₜ exceeds the threshold L_{TH} (NO in operation 505). When the level signal Lₒᵤₜ exceeds the threshold L_{TH} (YES in operation 505), the optical gain control is terminated. If it is not the correction timing (NO in operation 501), the optical gain control is not performed.

As described above, the controller 210A monitors the level signal Lₒᵤₜ of the signal output Iₒᵤₜ at predetermined timings to adjust the gain of the optical amplifier 205 by predicting transmission losses based on the environment data. In this manner, the level of the signal output Iₒᵤₜ can be maintained at levels exceeding the threshold L_{TH}. Furthermore, since changes in the transmission loss of the free space 300A can be predicted to control the gain of the optical amplifier 205, the signal output Iₒᵤₜ can be stabilized quickly and precisely.

### 3. ADDITIONAL STATEMENTS

Part or all of the above-described illustrative embodiments can also be described as, but are not limited to, the following additional statements.

### (Additional Statement 1)

A quantum cryptographic communication system comprising a transmitter and a receiver which are connected via a communication network,
wherein the transmitter and the receiver are optically connected through an optical transmission line,
the transmitter comprises:
   a beam splitter that splits coherent light into first light and second light; and
   an optical transmission section configured to: generate signal light having a quantum state by applying phase modulation and intensity attenuation to the first light, wherein the second light is used as reference light having no quantum state; and transmit the signal light and the reference light to the optical transmission line, and
the receiver comprises:
   an optical reception section configured to receive the signal light and the reference light arriving through the optical transmission line;
   an optical amplifier that amplifies the reference light received by the optical reception section while maintaining wavelength and phase of the reference light;
   a phase modulator that phase-modulates the reference light output from the optical amplifier;
   a homodyne detector that generates a signal output based on phase-modulated reference light and the signal light arriving through the optical transmission line;
   a level detector that detects a signal output level from the signal output; and
   an optical amplifier controller that controls a gain of the optical amplifier based on at least the signal output level.

### (Additional Statement 2)

The quantum cryptographic communication system according to additional statement 1, wherein the optical transmission line is an optical fiber.

### (Additional Statement 3)

The quantum cryptographic communication system according to additional statement 1, wherein the optical transmission section of the transmitter and the optical reception section of the receiver include optical transceivers, respectively, wherein optical axes of the optical transceivers are aligned with each other, wherein the optical transmission line is free space between the optical transceivers.

### (Additional Statement 4)

The quantum cryptographic communication system according to any one of additional statements 1-3, wherein the optical amplifier controller controls the gain of the optical amplifier so that the signal output level can be maintained within a predetermined range.

### (Additional Statement 5)

The quantum cryptographic communication system according to any one of additional statements 1-3, wherein the optical amplifier controller sets the gain of the optical amplifier to a value for compensating for loss of the optical transmission line.

### (Additional Statement 6)

The quantum cryptographic communication system according to any one of additional statements 1-5, wherein the receiver further comprises an optical gain calculator that calculates the gain of the optical amplifier based on the signal output level and environment data of the optical transmission line,
wherein the optical amplifier controller controls the gain of the optical amplifier based on the signal output level and the gain calculated by the optical gain calculator.

### (Additional Statement 7)

A communication device that detects a signal output by homodyne detection in a quantum cryptographic communication system, comprising:
an optical reception section configured to receive signal light and reference light arriving through an optical transmission line, wherein the signal light and the reference light are generated from coherent light at a transmitting-side communication device, wherein the signal light is weak-intensity light having a quantum state and the reference light is light having no quantum state;
an optical amplifier that amplifies the reference light received by the optical reception section while maintaining wavelength and phase of the reference light;
a phase modulator that phase-modulates the reference light output from the optical amplifier;
a homodyne detector that generates the signal output based on phase-modulated reference light and the signal light arriving through the optical transmission line;
a level detector that detects a signal output level from the signal output; and
an optical amplifier controller that controls a gain of the optical amplifier based on at least the signal output level.

### (Additional Statement 8)

The communication device according to additional statement 7, wherein the optical amplifier controller controls the gain of the optical amplifier so that the signal output level can be maintained within a predetermined range.

### (Additional Statement 9)

The communication device according to additional statement 7 or 8, wherein the optical amplifier controller sets the gain of the optical amplifier to a value for compensating for loss of the optical transmission line.

### (Additional Statement 10)

The communication device according to any one of additional statements 7-9, further comprising an optical gain calculator that calculates the gain of the optical amplifier based on the signal output level and environment data of the optical transmission line,
wherein the optical amplifier controller controls the gain of the optical amplifier based on the signal output level and the gain calculated by the optical gain calculator.

### (Additional Statement 11)

The communication device according to any one of additional statements 7-10, wherein the optical reception section includes an optical transceiver whose optical axis is aligned with that of an optical transceiver of the transmitting-side communication device, wherein the optical transmission line is free space between these optical transceivers.

### (Additional Statement 12)

A control method in a communication device that detects a signal output by homodyne detection in a quantum cryptographic communication system, comprising:
by an optical reception section, receiving signal light and reference light arriving through an optical transmission line, wherein the signal light and the reference light are generated from coherent light at a transmitting-side communication device, wherein the signal light is weak-intensity light having a quantum state and the reference light is light having no quantum state;
by an optical amplifier, amplifying the reference light received by the optical reception section while maintaining wavelength and phase of the reference light;
by a phase modulator, phase-modulating the reference light output from the optical amplifier;
by a homodyne detector, generating the signal output based on phase-modulated reference light and the signal light arriving through the optical transmission line;
by a level detector, detecting a signal output level from the signal output; and
by an optical amplifier controller, controlling a gain of the optical amplifier based on at least the signal output level.

### (Additional Statement 13)

The control method according to additional statement 12, wherein the optical amplifier controller controls the gain of the optical amplifier so that the signal output level can be maintained within a predetermined range.

### (Additional Statement 14)

The control method according to additional statement 12 or 13, further comprising:
by an optical gain calculator, calculating the gain of the optical amplifier based on the signal output level and environment data of the optical transmission line,
wherein the optical amplifier controller controls the gain of the optical amplifier based on the signal output level and the gain calculated by the optical gain calculator.

### INDUSTRIAL APPLICABILITY

The invention can be applied to optical modulators in optical communication systems, especially quantum key delivery systems.

### REFERENCE SIGNS LIST

10 Transmitter (Alice)
11 Phase modulator
12 Attenuator
13 Optical amplifier
14 Phase modulator
15 Subtractor
16 Signal output level detector
17, 17a Optical amplifier controller
18 Transmission Loss Predictor
BS1, BS2 Beam splitter
M1, M2 Mirror
C Optical transmission line
PD1, PD2 Photodetector
100, 100A Communication device (transmitter)
101 Laser light source
102 Unpolarizing beam splitter
103 Polarizing beam splitter
104 Mirror
105 Half-wave plate
106 Attenuator
107 Phase modulator
108 Mirror
109 Controller
111 Beam expander
200, 200A Communication device (receiver)
201 Polarizing Beam Splitter
202 Half-wave plate
203 Unpolarizing beam splitter
204 Mirror
205 Optical amplifier
206 Phase modulator
207 Mirror
208 Subtractor
209 Low-pass filter
210, 210A Controller
211 Beam expander
212 Various sensors
300 Optical fiber
300A Free space

What is claimed is:

1. A quantum cryptographic communication system comprising a transmitter and a receiver which are connected via a communication network,
wherein the transmitter and the receiver are optically connected through an optical transmission line,
the transmitter comprises
an optical transmission section configured to transmit signal light having a quantum state and reference light having no quantum state to the receiver through the optical transmission line, wherein the signal light and the reference light are generated from coherent light and
the receiver comprises:
an optical reception section configured to receive receiving-side signal light and receiving-side reference light arriving through the optical transmission line;
an optical amplifier that amplifies the receiving-side reference light while maintaining wavelength and phase of the receiving-side reference light;
a homodyne detector that generates a signal output based on the receiving-side reference light amplified by the optical amplifier and the receiving-side signal light;
a level detector that detects a signal output level from the signal output; and
an optical amplifier controller that controls a gain of the optical amplifier based on at least the signal output level.

2. The quantum cryptographic communication system according to claim 1, wherein the optical transmission line is an optical fiber.

3. The quantum cryptographic communication system according to claim 1, wherein the optical transmission section of the transmitter and the optical reception section of the receiver include optical transceivers, respectively, wherein optical axes of the optical transceivers are aligned with each other, wherein the optical transmission line is free space between the optical transceivers.

4. A receiving-side communication device that detects a signal output by homodyne detection from signal light and reference light transmitted by a transmitting-side communication device through an optical transmission line in a quantum cryptographic communication system, wherein the signal light and the reference light are generated from coherent light, wherein the signal light is weak-intensity light having a quantum state and the reference light is light having no quantum state, the receiving-side communication device comprising:
an optical reception section configured to receive receiving-side signal light and receiving-side reference light from the transmitting-side communication device through the optical transmission line;
an optical amplifier that amplifies the receiving-side reference light received by the optical reception section while maintaining wavelength and phase of the receiving-side reference light;
a homodyne detector that generates the signal output based on the receiving-side reference light amplified by the optical amplifier and the receiving-side signal light;
a level detector that detects a signal output level from the signal output; and
an optical amplifier controller that controls a gain of the optical amplifier based on at least the signal output level.

5. The receiving-side communication device according to claim 4, wherein optical amplifier controller controls the gain of the optical amplifier so that the signal output level can be maintained within a predetermined range.

6. The receiving-side communication device according to claim 4, wherein optical amplifier controller sets the gain of the optical amplifier to a value for compensating for loss of the optical transmission line.

7. The receiving-side communication device according to claim 4, further comprising an optical gain calculator that calculates the gain of the optical amplifier based on the signal output level and environment data of the optical transmission line,
wherein the optical amplifier controller controls the gain of the optical amplifier based on the signal output level and the gain calculated by the optical gain calculator.

8. A control method in a receiving-side communication device that detects a signal output by homodyne detection from signal light and reference light transmitted by a transmitting-side communication device through an optical transmission line in a quantum cryptographic communication system, wherein the signal light and the reference light are generated from coherent light, wherein the signal light is weak-intensity light having a quantum state and the reference light is light having no quantum state, the control method comprising:
by an optical reception section, receiving receiving-side signal light and receiving-side reference light from the transmitting-side communication device through the optical transmission line;
by an optical amplifier, amplifying the receiving-side reference light received by the optical reception section while maintaining wavelength and phase of the receiving-side reference light;
by a homodyne detector, generating the signal output based on receiving-side reference light and the receiving-side signal light;
by a level detector, detecting a signal output level from the signal output; and
by an optical amplifier controller, controlling a gain of the optical amplifier based on at least the signal output level.

9. The control method according to claim 8, wherein optical amplifier controller controls the gain of the optical amplifier so that the signal output level can be maintained within a predetermined range.

10. The control method according to claim 8, further comprising:
by an optical gain calculator, calculating the gain of the optical amplifier based on the signal output level and environment data of the optical transmission line,
wherein the optical amplifier controller controls the gain of the optical amplifier based on the signal output level and the gain calculated by the optical gain calculator.

11. The quantum cryptographic communication system according to claim 1, wherein the optical amplifier controller controls the gain of the optical amplifier so that the signal output level can be maintained within a predetermined range.

12. The quantum cryptographic communication system according to claim 1, wherein the optical amplifier controller sets the gain of the optical amplifier to a value for compensating for loss of the optical transmission line.

13. The quantum cryptographic communication system according to claim 1, wherein the receiver further comprises an optical gain calculator that calculates the gain of the optical amplifier based on the signal output level and environment data of the optical transmission line,
wherein the optical amplifier controller controls the gain of the optical amplifier based on the signal output level and the gain calculated by the optical gain calculator.

14. The receiving-side communication device according to claim 4, wherein the optical reception section includes an optical transceiver whose optical axis is aligned with that of an optical transceiver of the transmitting-side communication device, wherein the optical transmission line is free space between these optical transceivers.
